(19) United States
(12) Patent Application Publication
(10) Pub. No.: US 2013/0063573 A1
(43) Pub. Date: Mar. 14, 2013

(54) High Dynamic Range Displays Having Improved Field Sequential Processing

(71) Applicant: Gopal Erinjippurath, San Francisco, CA (US)

(72) Inventor: Gopal Erinjippurath, San Francisco, CA (US)

(73) Assignee: DOLBY LABORATORIES LICENSING CORPORATION, San Francisco, CA (US)

(21) Appl. No.: 13/228,807

(22) Filed: Sep. 9, 2011

(51) Int. Cl. H04N 13/04; G09G 5/02; G09G 3/36; G02F 1/1335; G09G 5/10

(52) U.S. Cl. 348/51; 362/97.1; 345/690; 345/694; 345/102

(57) ABSTRACT

Several embodiments of display systems are disclosed that comprise a backlight source, a first modulator, a second modulator and a controller. The backlight source may further comprise an edge-lit backlighting source that may be controlled to affect a field-sequential illumination for the dual or multiple modulator display system. In another embodiment, the display system may comprise two or more color primary emitters that each comprise a color gamut. When the color gamuts are driven in a field sequential pattern, the resulting overall gamut is substantially wider. Other display systems and methods are disclosed herein that affect a variety of 3D viewing embodiments.

### TECHNICAL FIELD

The present invention relates to displays systems and, more particularly, to novel high dynamic display systems employing improved field sequential processing.

### BACKGROUND

In the field of high contrast, energy efficient, wide color gamut displays, it is known to create displays comprising a backlight of discrete independently controllable emitters (e.g. LEDs—both inorganic and organic) and a high resolution LCD panel. The combination of a low resolution backlight and a high resolution LCD panel (i.e. “dual modulator displays”) is disclosed further in co-owned: (1) U.S. Pat. No. 7,753,530 entitled “HDR DISPLAYS AND CONTROL SYSTEMS THEREFOR”; (2) United States Patent Application Publication Number 2009322800 entitled “METHOD AND APPARATUS IN VARIOUS EMBODIMENTS FOR HDR IMPLEMENTATION IN DISPLAY DEVICES”; (3) United States Patent Application Publication Number 2009284459 entitled “ARRAY SCALING FOR HIGH DYNAMIC RANGE BACKLIGHT DISPLAYS AND OTHER DEVICES”; (4) United States Patent Application Publication Number 2008018985 entitled “HDR DISPLAYS HAVING LIGHT ESTIMATING CONTROLLERS”; (5) United States Patent Application Publication Number 20070268224 entitled “HDR DISPLAYS WITH DUAL MODULATORS HAVING DIFFERENT RESOLUTIONS”; (6) United States Patent Application Publication Number 20070268211 entitled “HDR DISPLAYS WITH INDIVIDUALLY-CONTROLLABLE COLOR BACKLIGHTS”; (7) United States Patent Application Publication Number 20100214282 entitled “APPARATUS FOR PROVIDING LIGHT SOURCE MODULATION IN DUAL MODULATOR DISPLAYS”; (8) United States Patent Application Publication Number 20090201320 entitled “TEMPORAL FILTERING OF VIDEO SIGNALS”; (8) United States Patent Application Publication Number 20070268695 (“the '695 application”) entitled “WIDE COLOR GAMUT DISPLAYS”—all of which are hereby incorporated by reference in their entirety.

Field sequential processing, as a technique for rendering color images, are well known in the art. For example, the following are examples of such field sequential display systems: (1) United States Patent Application Publication Number 20080253455 entitled “HIGH FRAME MOTION COMPENSATED COLOR SEQUENCING SYSTEM AND METHOD”; (2) United States Patent Application Publication Number 20070152945 entitled “LIQUID CRYSTAL DISPLAY OF FIELD SEQUENTIAL COLOR TYPE AND METHOD FOR DRIVING THE SAME”; (3) United States Patent Application Publication Number 20110063330 entitled “METHOD AND APPARATUS FOR REDUCING ERRONEOUS COLOR EFFECTS IN A FIELD SEQUENTIAL LIQUID CRYSTAL DISPLAY”; (4) United States Patent Application Publication Number 20110063333 entitled “COLOR SEQUENTIAL DISPLAY AND POWER SAVING METHOD THEREOF”—and are all hereby incorporated by reference in their entirety.

Typical field sequential display systems strive to present a sequence of differing, single primary color frames (that would typically combine to form a white color, if shown simultaneously) and have image data be analyzed to drive a modulator (such as an liquid crystal display, LCD)—at a suitably high frame rate—that the resulting sequence of images look pleasing to a viewer. It is known in the art that this type of image rendering sometimes has unpleasant viewing artifacts, such as color break-up, and some display systems try to reduce or minimize these effects by various techniques, including employing very high frame rates.

### SUMMARY

Several embodiments of display systems and methods of their manufacture and use are herein disclosed.

In one embodiment, a display system comprises a field sequential backlight, a first modulator and a second modulator.

In yet another embodiment, a display system comprises a backlight source, a first modulator, a second modulator and a controller. The backlight source may further comprise an edge-lit backlighting source that may be controlled to affect a field-sequential illumination for the dual or multiple modulator display system.

In another embodiment, the display system may comprise two or more sets of color primary emitters such that each comprise a color gamut. When the color gamuts are driven in a field sequential pattern, the resulting overall gamut is substantially wider.

In yet another embodiment, the display system may comprise a lenticular lens sheet for affecting autostereoscopic 3D viewing. In other embodiments, the display system may comprise a matched polarizer to condition the light in the display system to operate with stand-alone polarized viewing glasses that affect a 3D viewing of image. In yet another embodiment, the display system may comprise a stand-alone active shutter glasses, such that the active shutter glasses are synchronized with the subpixels of the second modulator, in order to affect a 3D viewing of images.

Other features and advantages of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A shows an embodiment of a display made for high dynamic range comprising a field sequential backlight and two LCD modulators.

FIG. 1B shows one embodiment of an image processing pipeline for a display made in accordance with the embodiment of FIG. 1A.

FIG. 1C shows yet another embodiment of an image processing pipeline for a display made in accordance with the embodiment of FIG. 1A.

FIG. 2 shows one embodiment of a backlighting system and scheme for implementing edge-lighting for a display system.

FIG. 3 depicts one embodiment of a temporal processing scheme that employs a backlighting system and scheme of FIG. 2.

FIGS. 4A and 4B show the gamut effects of the backlighting system and scheme of FIG. 2 during two different time periods.

FIG. 5 shows the overall gamut performance of a backlighting system of FIG. 2.

FIGS. 6 through 9 are different embodiments and variations of temporal backlighting schemes using the backlighting system of FIG. 2.

FIG. 10 is one embodiment of a dual or multiple modulator display system that affects 3D visual effects stereoscopically.

FIG. 11 shows one embodiment of a dual or multiple modulator display system that comprises a lenticular lens array for multi-view a utostereoscopy.

FIG. 12 shows one embodiment of a dual or multiple modulator display system that utilizes active shutter glasses to affect 3D viewing.

FIG. 13 shows one embodiment of an input stereoscopic video sequence or still image frame may be used to create multiple views on a display system such as shown in FIG. 11.

FIG. 14 shows one embodiment in which the system of FIG. 13 further comprises a multi-view codec for displaying multi-view autostereoscopic video sequences and frames.

FIG. 15 shows the spectral content and performance of conventional CCFL backlight and conventional colored filter arrays used in standard LCDs.

FIG. 16 shows one embodiment of the spectral performance of OLED emitters, either broad spectrum or RGB, together with matching color filters to give even illumination across a broad spectrum.

### DETAILED DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

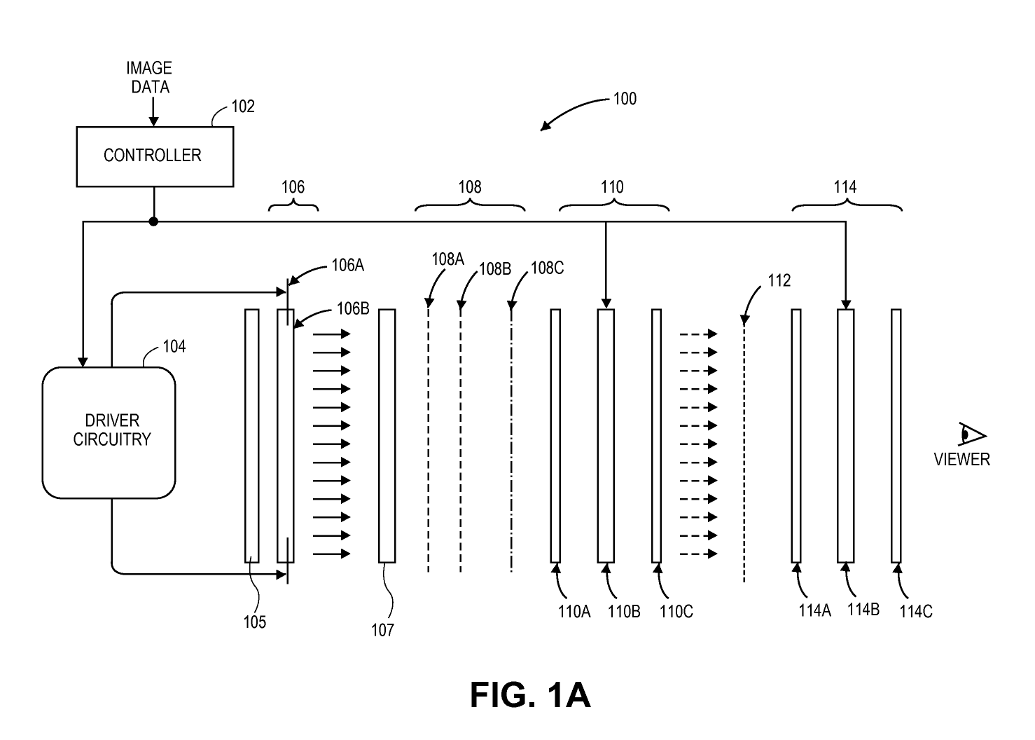

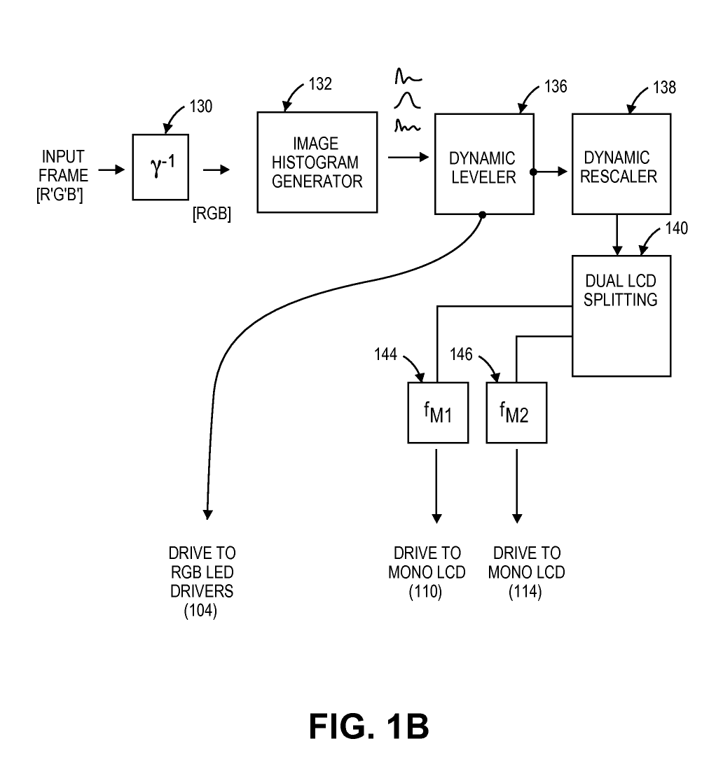

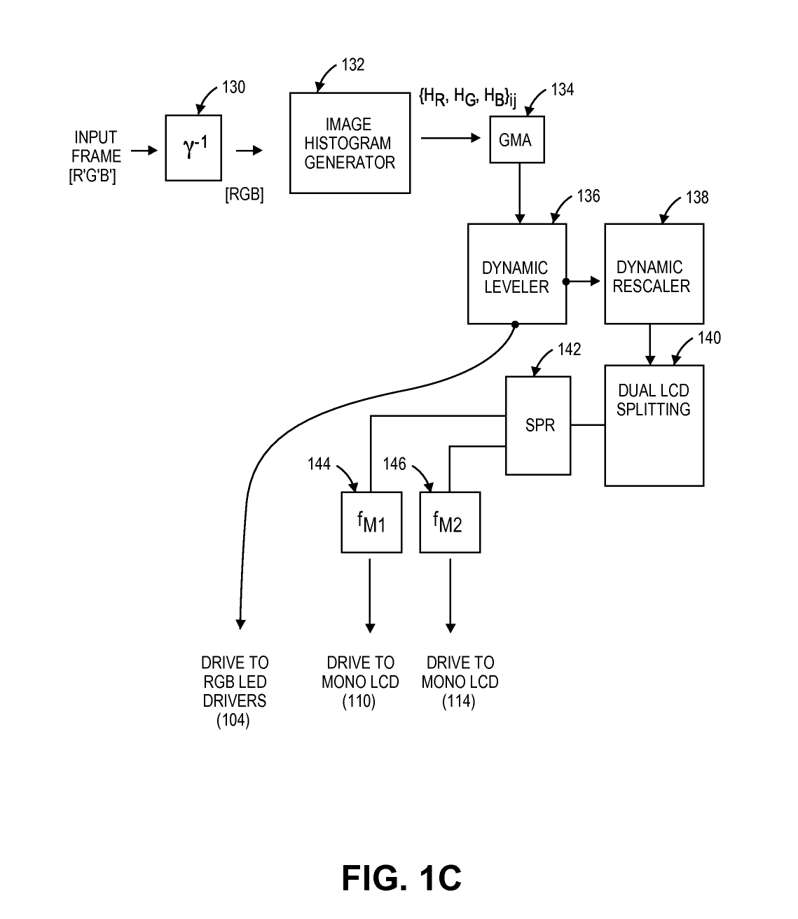

High dynamic range display systems are increasingly making their way into consumer display products. Several different display system configurations have attempted to affect high dynamic range. One such configuration is shown in FIG. 1 of the '695 application noted above. That configuration is a low resolution array of colored LED backlights that illuminates one side of a higher resolution LCD panel. The combination of separately modulated LED backlights, together with a separately modulated LCD panel, produces a display of very high dynamic range. However, the cost of such a display is driven in part by the cost of the LED backlights and the processing requirements needed to implement the dual modulated display. The processing requirements of such a system also depend upon the number of different LEDs whose light may transmit through any given subpixel of the LCD panel. As a rule of thumb, the more LEDs illuminating a LCD subpixel, the more processing is required to accurately and faithfully reproduce a rendered image thereon.

Edge-Lit Dual Panel Display System Embodiment

To produce a display that exhibits a similar high dynamic range; but without the cost of a backlight comprising an array of colored LEDs, various configurations are possible.

FIG. 1A is one such embodiment of a display system 100 that achieves high dynamic range without a separately modulated backlight. Broadly, display system 100 comprises a field sequential backlight 106 that emits light into an optical path (denoted by arrow emanating from backlight 106). Light in this optical path is modulated by a first modulator 110 and then by a second modulator 112. As will be discussed in greater detail below, this embodiment avoids the typical higher cost of previous high dynamic range display systems (having a backlight comprising an array of separately controllable LED emitters, as noted above) by employing a potentially smaller number of emitters forming an edge-lit display.

Other examples of such high dynamic range displays that comprises at least two LCD panels, the following commonly-owned applications: (1) U.S. patent application Ser. No. 12/780,740 filed on May 14, 2010 entitled “HIGH DYNAMIC RANGE DISPLAYS USING FILTERLESS LCD(s) FOR INCREASING CONTRAST AND RESOLUTION” (Attorney Docket No. D10026US01); (2) Provisional U.S. Patent Application No. 61/479,966 filed on Apr. 28, 2011, entitled “DUAL PANEL DISPLAY WITH CROSS BEF COLLIMATOR AND POLARIZATION-PRESERVING DIFFUSER” (Attorney Docket No. D11006USP1); (3) Provisional U.S. Patent Application No. 61/450,802 filed on Mar. 9, 2011, entitled “HIGH CONTRAST GRAYSCALE AND COLOR DISPLAYS” (Attorney Docket No. D11011USP1)—all of which are incorporated by reference in their entirety. These other displays also utilize dual modulator panels, together with a simpler backlighting scheme.

Continuing with the discussion of the embodiment of FIG. 1A, a more complete description of the display system follows—in order from inside components toward the viewable part of the display. Driving circuitry 104 drives emitters 106A (e.g. LED or other suitable emitters known in the art). Light from emitters 106A is dispersed by light waveguide 106B. Light that moves away from the optical path may be reflected back into the path by reflector 105 (e.g. ESR film, daylight film or the like).

Light collimation stack 108 may comprise bulk diffuser 107, BEF or prismatic film 108A, cross BEF or prismatic film 108B (possibly at 90 degrees relative to film 108A), DBEF film or reflective polarizer 108C. First modulator 110 may comprise polarizer 110A (possibly at +45 degrees), first modulator panel 110B (e.g. LCD panel or the like) and polarizer 110C (possibly at −45 degrees).

After first modulator 110, light may pass through diffuser 112 (which may be a polarization preserving or a holographic diffuser) before passing through second modulator 114. Second modulator 114 may comprise polarizer 114A (possibly at −45 degrees), second modulator panel 114B (e.g. LCD panel or the like) and polarizer 114C (possibly at +45 degrees). Light emanating from second modulator 114 is directly viewable as shown.

In one embodiment, first modulator panel 110B and second modulator panel 114B may both be monochrome LCD panels in operation with colored LEDs aligned in an edge-lit manner. In another embodiment, one or both of the first modulator panel 110B and second modulator panel 114B may comprise colored subpixels in operation with either colored LEDs or white LEDs aligned in an edge-lit manner. If both LCD panels are monochrome, then the throughput of light from the display system is increased, due to the absence of the color filter array (CFA) or avoidance of colored subpixel filters. Such brightness and energy efficiency increases may be further enhanced if the two monochrome LCDs are driven in tandem on a pixel-by-pixel basis in real time.

Additionally, very high contrast could be achieved with such a display system. The high contrast achieved by the optical multiplicative action of the two monochrome LCDs would allow for the accurate representation of high dynamic range motion imagery without light source modulation. However, for the accurate representation of wide color gamut (WCG), modulating the light source allows for the display of highly saturated colors when using light sources with a single or multiple dominant wavelengths.

In one embodiment, the light sources may comprise a set of LEDs. However, these LEDs may be substituted by other light emitters in commercial production like Organic LEDs (OLED), Quantum Dots (QD) or solid state lasers (SSL). It will also be appreciated that, in the various descriptions of embodiments, the monochrome LCDs may include active matrix LCDs, trans-reflective LCDs, window LCDs.

Field Sequential Color Processing with Edge-Lit Dual Panel Display

In reference to continued discussion of this embodiment, it will be assumed that the backlight comprises colored LEDs aligned in an edge-lit manner. In operation, image data is input into controller 102 which, after certain image processing steps (e.g. gamut mapping algorithms (GMA) or subpixel rendering algorithms (SPR), as are known in the art) may send image data and control signals to driver circuitry 104 and to first modulator panel 110B and second modulator panel 114B.

In one embodiment, edge-lit backlight 106 may comprise a set of colored emitters—e.g., red (R), green (G) and blue (B) LED emitters (and possibly other colored emitters as well, but for purposes of illustration, consider just R, G, B emitters for now)—wherein each R emitter is substantially one primary color in the red spectrum, each G emitter substantially one primary color in the green spectrum and each B emitter substantially one primary color in the blue spectrum (i.e. to within a certain degree of manufacturing tolerances). In such a display system, controller 102 may analyze image data for sending out control signals to first modulator panel 110B and second modulator panel 114B—to properly adjust the modulators (e.g. individual subpixels) to set the appropriate transmissiveness during each red, green and blue field to faithfully render the desired image.

In another embodiment, it is possible to employ an edge-lit backlight 106 comprising a set of colored emitters—e.g., red (R), green (G) and blue (B) LED emitters (and possibly other colored emitters as well, but for purposes of illustration, consider just R, G, B emitters for now). However, instead of using substantially one primary color per emitter (e.g. each R emitter is substantially one primary color in the red spectrum, etc.), backlight 106 may comprise, e.g., two or more primary colors in the red spectral region to produce the “red” color in the light path of the display system. It is also possible to utilize two or more primary colors in a subset or in each of the distinct spectral regions desired (e.g. two or more different “red” emitters, “green” emitters, “blue” emitters, “yellow” emitters, “cyan” emitters or the like as desired.) The proper selection of two or more “red” emitters may be accomplished by proper binning of red emitters and separating according to color output.

With such a display configuration, it is possible to group different emitters together, in various ways and combinations to affect a field sequential scheme having a wider color gamut, as compared to a more conventional field sequential system. Just for illustrative purposes, suppose the backlight comprised two “reds” (R1 and R2), two “greens” (G1 and G2) and two “blues” (B1 and B2). In that case, two white light spectrums may be produced by [R1, G1, B1] and [R2, G2, B2] sets of emitters. It will be appreciated that the selection of only R, G and B is not limiting, and that any other set of colored emitters (yellow, cyan, magenta or the like) may be used in a like fashion. In addition, variations of different sets of colored emitters may be used dynamically to create a white light—to affect a field sequential fashion. Controller 102 generates the control signals for the backlight array and the two monochrome LCDs. It may use scene analysis for determining the optimal order of driving the multi-primary light emitters based on the incoming input image frame in the video sequence for playback on the display.

FIG. 1B describes one embodiment of an image processing pipeline (or otherwise, a flow diagram) of the embodiment that may affected by controller 102 that generates the drive signals for the light emitter drivers 104 and the two monochrome LCDs 110 and 114. The incoming image frame from a video sequence intended to be viewed on the display embodiment may first go through an inverse gamma correction 130 function to represent the image pixel data in linear space. The corrected image may then be processed by the image histogram generator 132 to generate the histograms for the R, G and B color channels (or whatever color channels are provided by the display system). Based on the histograms, preliminary scene analysis is performed by dynamic leveler module 136 to determine the optimal signal of the different color channel LEDs for the particular frame. Based on this signal a distinct drive value is each of the RGB color light emitters. Based on the drive values for the individual channels and the peak drive value, the independent color channel images may then be rescaled in dynamic rescaler 138. The output of the rescaler is run through the dual LCD splitting 140 (that, e.g., may affect a square root function or the like) to generate linear drive values. However, the monochrome LCDs may have distinct LCD transmissivity functions that transform an input drive value to transmit light that is a percentage of the peak light transmission. By inverting these transmission functions, drivers 144 and 146 respectively generate signals for the two monochrome LCDs 110 and 114 respectively.

Yet another scheme for reducing the effect of color break-up is to employ “virtual primaries”—in which two or more different color emitters (e.g. green and blue) may be illuminated simultaneously to make a new “virtual” primary dynamically (e.g. cyan, in the present example). Such virtual primaries may be created according to image processing analysis of the image frame being currently rendered. Field sequential processing techniques using virtual primaries are known and discussed further in United States Patent Application Publication Number 20090174638 entitled “HIGH DYNAMIC CONTRAST DISPLAY SYSTEM HAVING MULTIPLE SEGMENTED BACKLIGHT” and United States Patent Application Publication Number 20080253445 entitled “COLOR CONVERSION UNIT FOR REDUCED FRINGING”—which are herein incorporated by reference in their entirety. In fact, it is possible to combine the various techniques of multiple primary sets, together with the techniques of virtual primaries to gain additional wide color gamut performance.

The concept of virtual primaries can be very effectively extended to the dual mono LCD based FSC system. As illustrated by the embodiment in FIG. 1C, a gamut mapping algorithm module, GMA 134, when used in conjunction with dynamic leveler 136 can be combined with a set of primaries to create virtual primaries with varying levels of de-saturation. In addition, if the backlight LEDs drivers are controlled by pulse width modulation (PWM), it may be possible to control the addressable color space for a specific region on the screen for a specific period of time in this fashion. Also, the combination of the dynamic leveler 136 for LED backlight drivers and for the choice of optimal virtual primaries, and the dynamic rescaler 138 for the optimal choice of LCD drive values can allow for reduced flicker which is predominant problem with FSC system as documented in literature. The inclusion of the sub-pixel rendering (SPR) algorithm module 142 can further enhance the viewing experience of the display constructed with this embodiment for providing better luminance and chrominance balance in the final rendered image from the display system, as is known in the art, by controlling the individual subpixel control signal values.

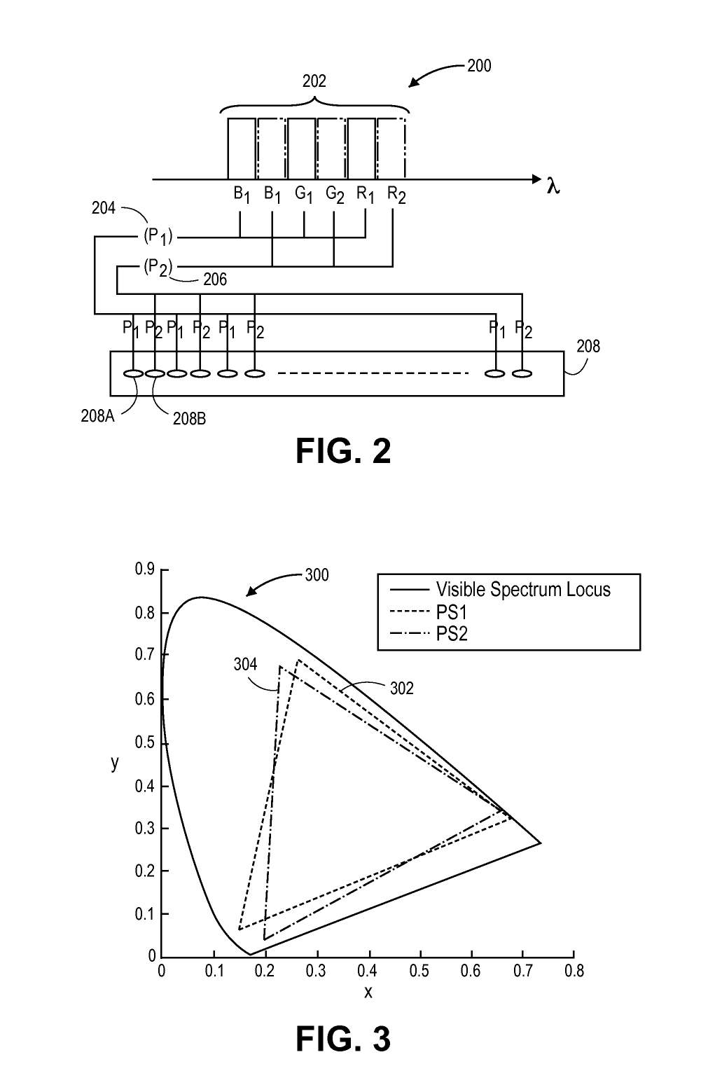

FIG. 2 is one embodiment of a backlight scheme 200 for affecting multiple primary sets in such a display system. Supposing a display system comprises two white light spectrums (as noted above, [R1, G1, B1] and [R2, G2, B2]), then controller 102, after analyzing image data, may send out control signals to these two sets of primaries—labeled P1 (204) and P2 (206) respectively. Backlight 208 may have a suitable interweaving of the different colored emitters (208A, 208B etc.) to affect a pleasing (and even) white lighting across the entire display during field sequential processing.

It will be appreciated that these emitters may comprise one of many different types of narrow band color sources—such as, narrow band, specifically binned LED emitters, quantum dot, quantum dot enhancement film (e.g. QDEFTM), laser light sources and the like.

Assuming this physical distribution of emitters along the backlight, then one embodiment of temporal processing may proceed as shown in FIG. 3. FIG. 3 depicts the CIE 1931 color space and two separate color gamuts presented by PS1 primaries (302) and PS2 primaries (304) in this example. With these two separate color gamuts now realizable, it is possible to employ them in a temporal fashion to effect an overall wider color gamut for the display system (i.e. than if the display had only a single color gamut, say PS1).

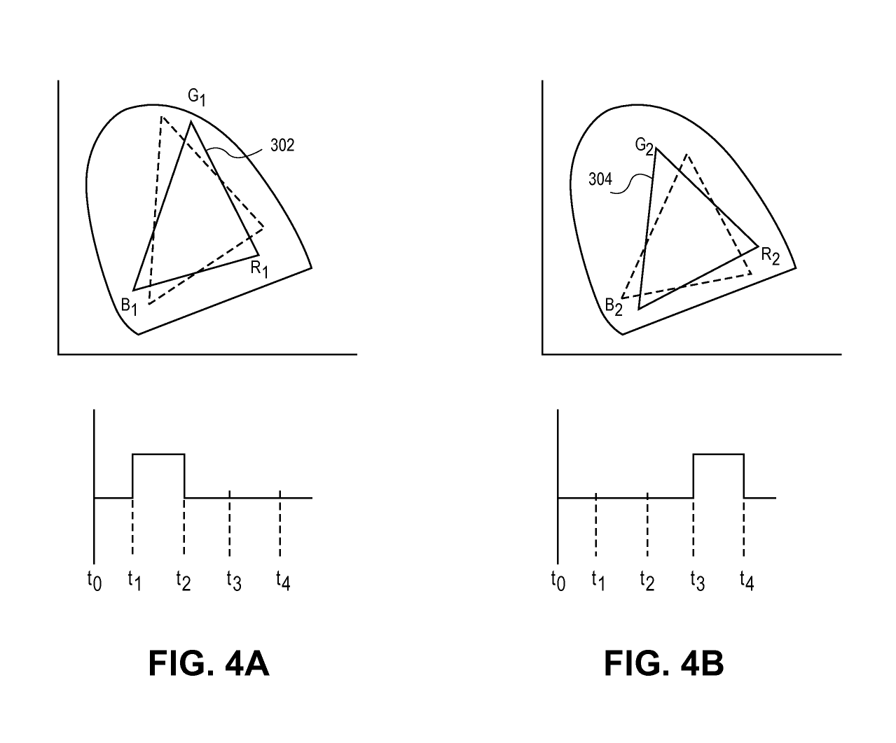

FIGS. 4A and 4B depict two separate time periods—one time period in which PS1 (302) is the active color gamut of the display system (e.g. using [R1, G1, B1] during one time interval of at least three frames) and another time in which PS2 (304) is the active color gamut of the display system (e.g. using [R2, G2, B2] during this second time interval of at least three frames).

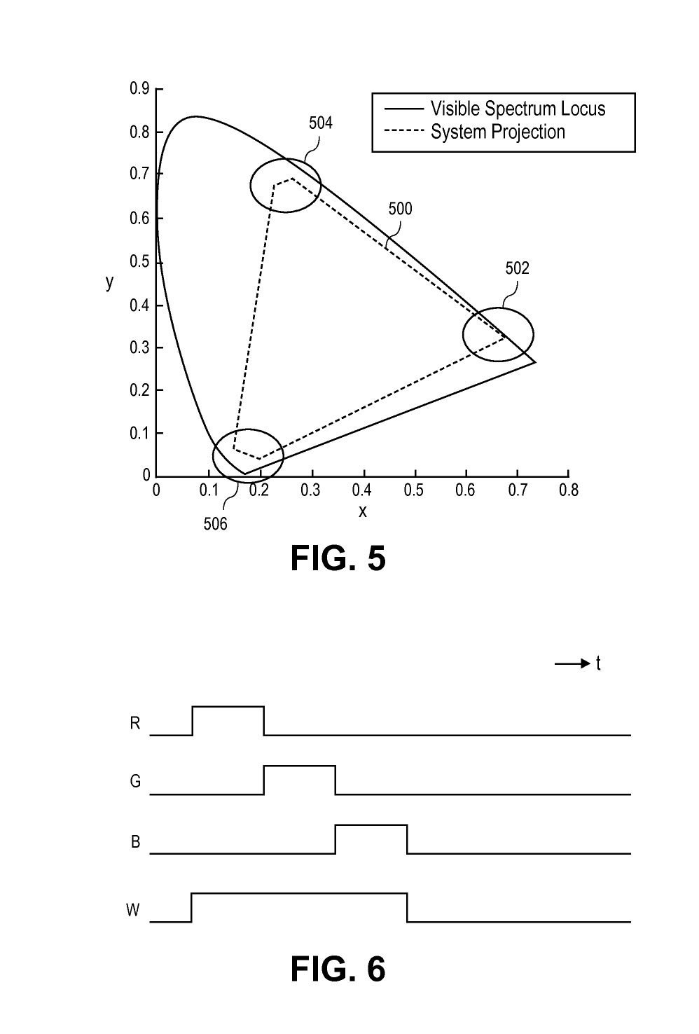

The overall effect of this temporal, field sequential processing is shown in FIG. 5. It should be noticed that the gamut 500 of this display system now appears to have substantially 6 vertices (in regions 502, 504 and 506), corresponding to primary points R1, R2, G1, G2, B1 and B2. This wider gamut may more accurately approximate the color gamut representations found in theatrical content, such as a six primary color gamut.

Many other variations and elaborations are now possible with such a field sequential display system. FIGS. 6 through 9 are different embodiments of field sequential processing schemes to reduce known undesirable effects of field sequential processing. FIG. 6 is one embodiment in which RGBW backlighting scheme is shown. RGBW backlighting may provide an opportunity to reduce and/or ameliorate the well-known and undesirable effect of color break-up. In FIG. 6, a white light (W) provides a base of luminance while R, G and B emitters may supply additional chrominance in the resulting image. This W light may be provided by the existing R, G, B emitters (or whatever color emitters there are in the backlight, including separate white emitters).

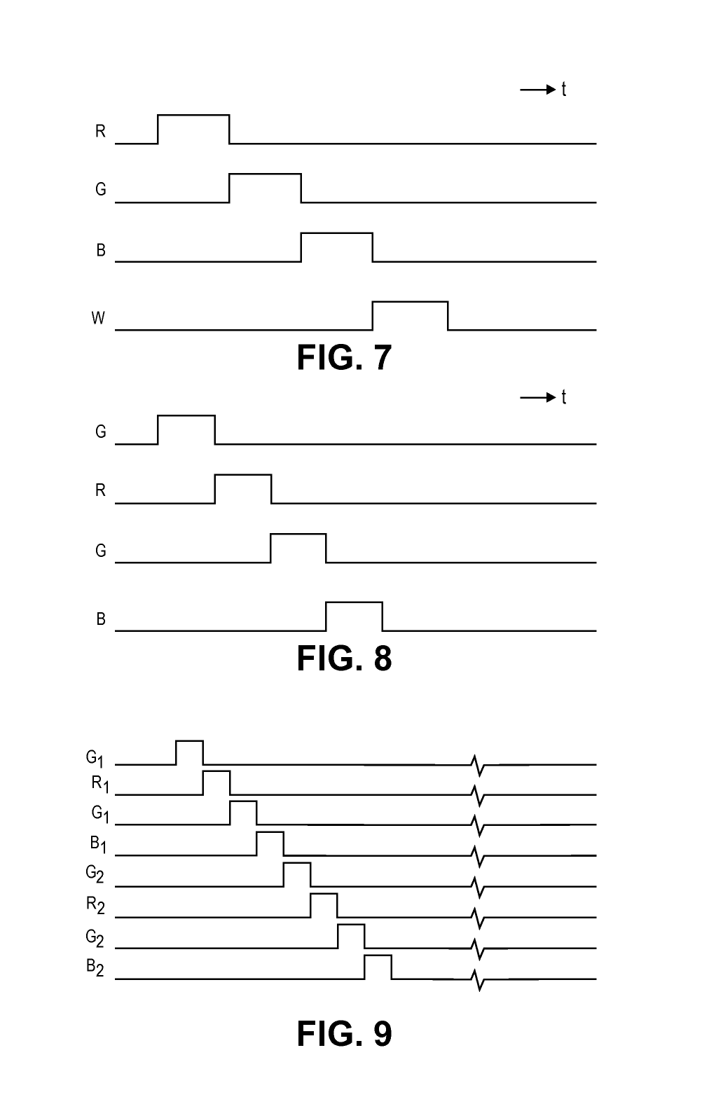

FIG. 7 shows another scheme for RGBW field sequential processing, in which one of the temporal slots is reserved for a W field. FIG. 8 is yet another field sequential scheme that may help reduce the effects of color break-up. In this embodiment, the G field is repeated in the field sequence. This concept of using repeated green primaries to reduce color break up can be extended to the embodiments described in FIG. 2 and FIG. 3. It suffices that a high-luminance color field (e.g. like green or other bright primary color, perhaps as a virtual primary) have a higher frequency in whatever illumination scheme affected by the controller to help abate color break-up, than other lower-luminance color fields (e.g. blue or red).

FIG. 9 is still yet another embodiment in which the G field is repeated; but this time in the context of two or more colored primary sets—e.g., P1 and P2. For such multi-primary backlighting schemes, it may be desirable to increase the backlighting refresh rate. For example, if the LCD displays are rated for 240 Hz, then the backlight may be refreshed at a minimum of 240 frames per second. Certain blue phase mode LCDs have been shown to be capable of clocking at such high frame rates.

Embodiments for Enhanced 3D Visual Effects

With the various embodiments of a dual modulator display system having edge-lit backlights, it is now possible to disclose systems and techniques for enhanced 3D visual effects, including autostereoscopic effects.

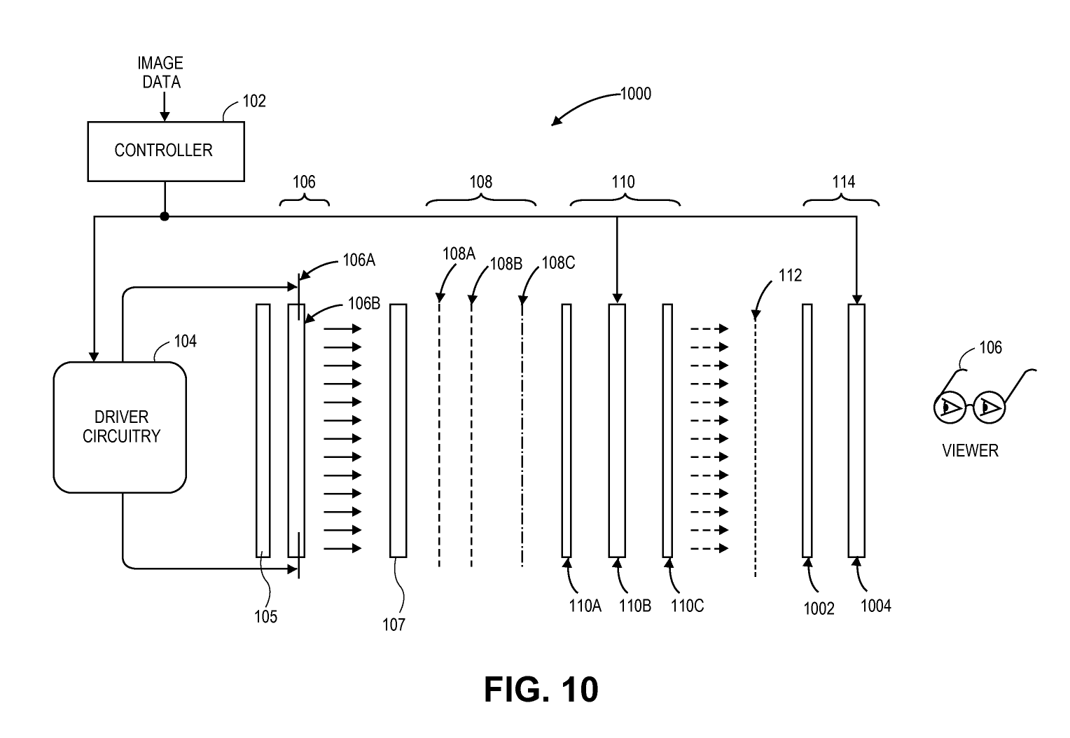

FIG. 10 is one embodiment of a dual modulator display system (1000) that shares many of the same elements as found in FIG. 1A display system. One difference between the two display systems is found at the second modulator 114. Second modulator 114 may comprise matched polarization analyzer 1002 and monochrome liquid crystal 1004.

Matched polarizer 1002 may be controlled to output images for respective right and left channels. The channels may be, for example, a left eye viewing channel or a right eye viewing channel that may be separated for viewing by stand-alone viewing glasses 1006 that include different filters for the left eye and right eye. For example, display 1000 could be energized to alternately display a left view and a right view of a 3D image. The images would then be separated into different corresponding viewing channels by energizing the additional controllable polarizer to polarize each of the images consistent with its viewing channel. For example, in a left and right polarization viewing system, the glasses 1006 could be constructed to include a P polarization filter on the left eye lens and an S polarization filter on the right eye lens. In such a case, controllable panel 1002 may be energized to pass/convert light modulated with left image data to a P polarization and pass/convert light modulated with right image data to S polarization.

In another example, the light may modulated with left or right image data in sections (e.g., light being emitted from the display at any given time contains parts of both a left and right channel image), and the controllable polarizer panel is also energized in sections and synchronized with the displayed image sections to convert those sectional images to the appropriate polarization and subsequent viewing through polarized filters by the left and right viewing channels.

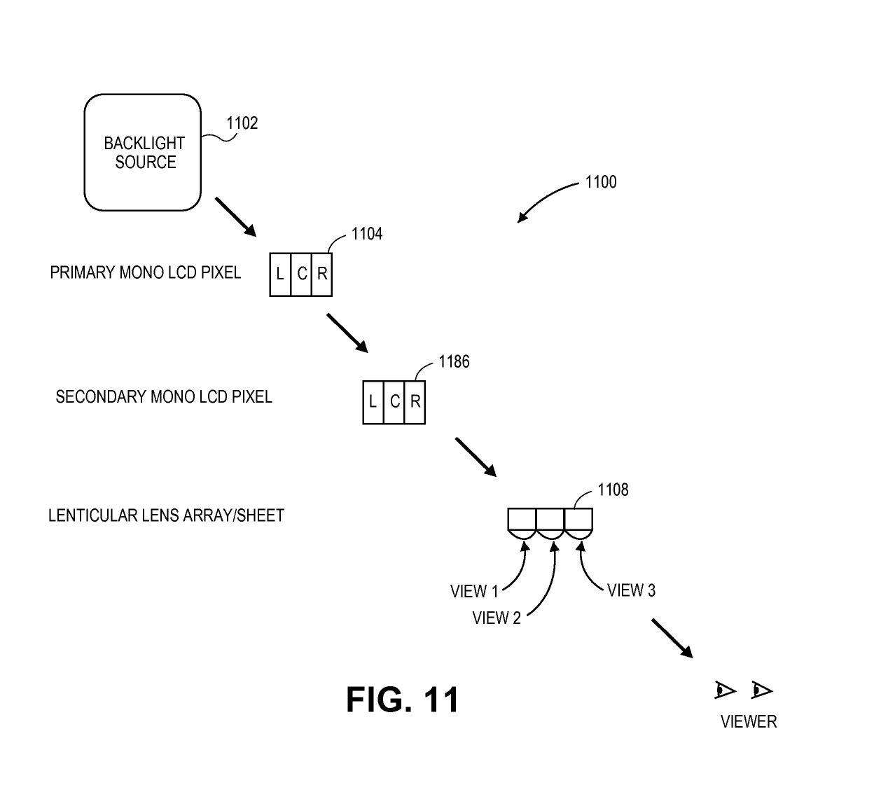

FIG. 11 is another embodiment of a dual modulator display system 1100 having high dynamic range and capable of affecting 3D images without the need of a matching set of glasses worn by a viewer. As is known in the art, it is possible to affect 3D viewing in an autostereoscopic manner. Some known systems are disclosed in: (1) United States Patent Application Publication Number 20110038043 entitled “SEGMENTED LENTICULAR ARRAY USED IN AUTOSTEREOSCOPIC DISPLAY APPARATUS”; (2) United States Patent Application Publication Number 20100118218 entitled “BACKLIGHTING SYSTEM FOR A 2D/3D AUTOSTEREOSCOPIC MULTIVIEW DISPLAY”; (3) United States Patent Application Publication Number 20100079584 entitled “2D/3D SWITCHABLE AUTOSTEREOSCOPIC DISPLAY APPARATUS AND METHOD”; (4) United States Patent Application Publication Number 20090207237 entitled “METHOD AND DEVICE FOR AUTOSTERIOSCOPIC DISPLAY WITH ADAPTATION OF THE OPTIMAL VIEWING DISTANCE”; (5) United States Patent Application Publication Number 20030025995 entitled “AUTOSTEREOSCOPIE”—all of which are incorporated by reference herein in their entirety.

In this embodiment of FIG. 11, backlight source 1102, such as an edge-lit, field sequential backlighting system as depicted in FIG. 2 or any other suitable backlight, may provide backlight for a dual modulator system such as, for example, depicted in FIG. 1A, or as shown in any another other dual modulator display in any of the commonly-owned patent applications incorporated by reference above.

Each pixel structure 1104 in the first and/or primary modulator (e.g. monochrome LCD) may be designated as left (L), center (C), or right (R) viewing—or however many different viewing areas are designated. The light from these pixel structures 1104 are matched with pixel structures in second and/or secondary modulator (e.g. another monochrome LCD).

As light emanates from the secondary pixel structure 1106, the light is further conditioned with a lenticular lens array and/or sheet 1108. Lenticular array 1108 affects the various light paths to the various viewing areas—e.g. left, center and right viewing areas, as seen by the viewer. As may be appreciated, this display system comprising a dual modulator, with both modulators comprising monochrome subpixels, allows for a brighter image due to the lack of usual reduction in brightness from colored subpixels. Also, the presence of LCR subpixels effectively provides for 3 distinct views without reducing the resolution of the displayed images. In addition, with the enhanced temporal and/or field sequential backlights with enhanced gamut performance, would allow higher chrominance fidelity for movies and other image sources where fidelity is a part of the viewer's experience. The resolution and/or dimensions of the lenses within the lenticular array/sheet may be optimized such that the lenses are the substantially the same size as that of the subpixel width.

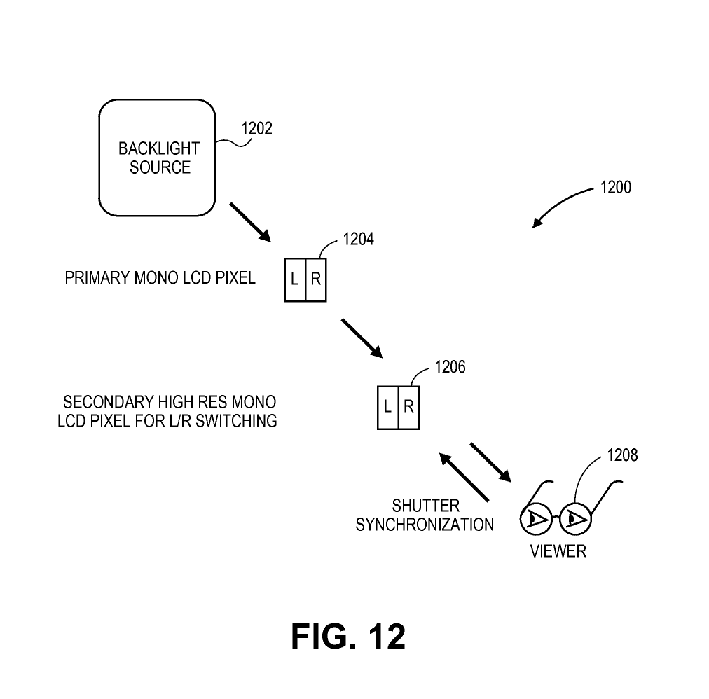

FIG. 12 is yet another embodiment of a dual modulator display system 1200 in which light from a suitable backlight 1202 is transmitted through a first or primary monochromatic pixel 1204 and then through a secondary monochrome pixel 1206. The secondary monochrome LCD pixel may function as a switch [ON/OFF] at multiple (for one example, twice) the frame rate of the primary monochrome LCD pixel. The shutter LCD may be synced to the active shutter eye wear 1208 so that alternating pixels are viewed by either one of the eyes to create the 3D viewing experience. Alternately, the secondary monochrome LCD can function in tri-state where it alternates between LₒₙR_{off}, L_{off}R_{off} and L_{off}Rₒₙ. This may allow for cross-talk reduction in active shutter glass based 3D viewing.

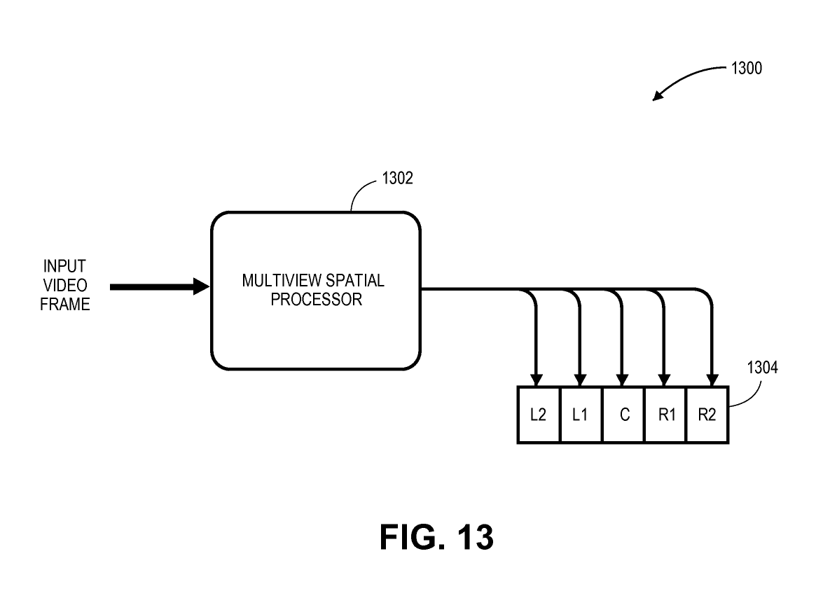

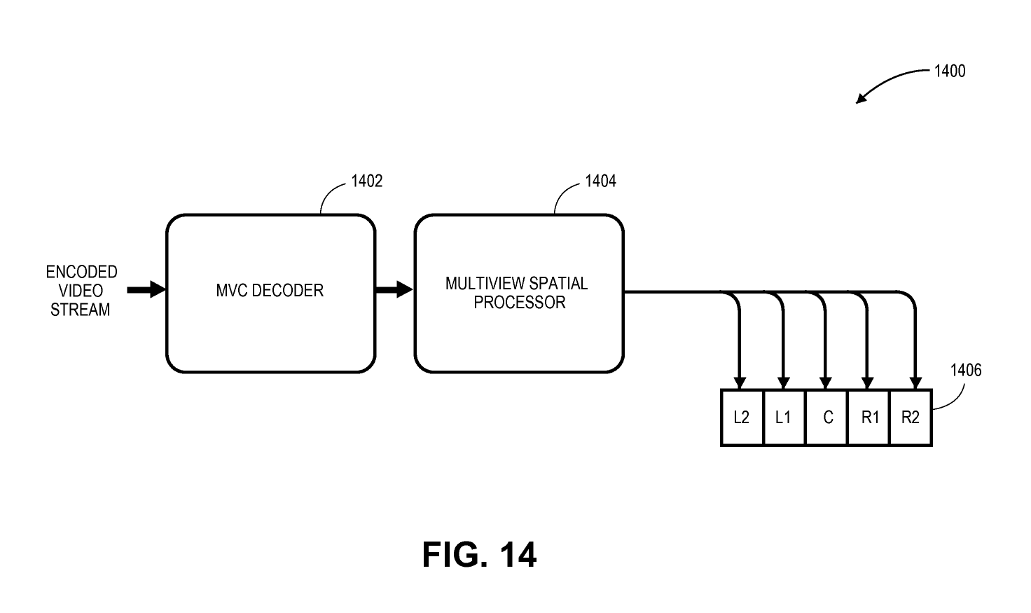

FIGS. 13 and 14 are two embodiments of an image processing pipeline for a dual modulator display system that might render 3D images, such as found in autostereoscopic systems, e.g., FIG. 11 or in system such as FIG. 12. Image pipeline 1300 inputs stereo frame from a video sequence to synthesize and render multiple views of the scene which may be optimized for a particular multiview 3D system that uses the embodiments in FIG. 11.

Spatial processor 1302 is seen outputting multiple channels of image data—in this embodiment, five channels: L2, L1, C, R1 and R2—thereby creating five views for autostereoscopy. These five channels may be employed as different views, to affect 3D viewing—as is known in the art.

FIG. 14 is yet another embodiment of an image processing pipeline 1400 wherein an MVC decoder 1402 is added as a pre-processing step to construct bitstreams that represent more than one view of a video scene—as done, for example, in stereoscopic 3D viewing. The MVC decoder 1402 decodes from up to 16 views of the scene into N views (where N may be any number less than or equal to 16) that are presented on the autostereoscopic display, as described, e.g., in FIG. 11.

Novel White-Light Background Edge Lighting Techniques

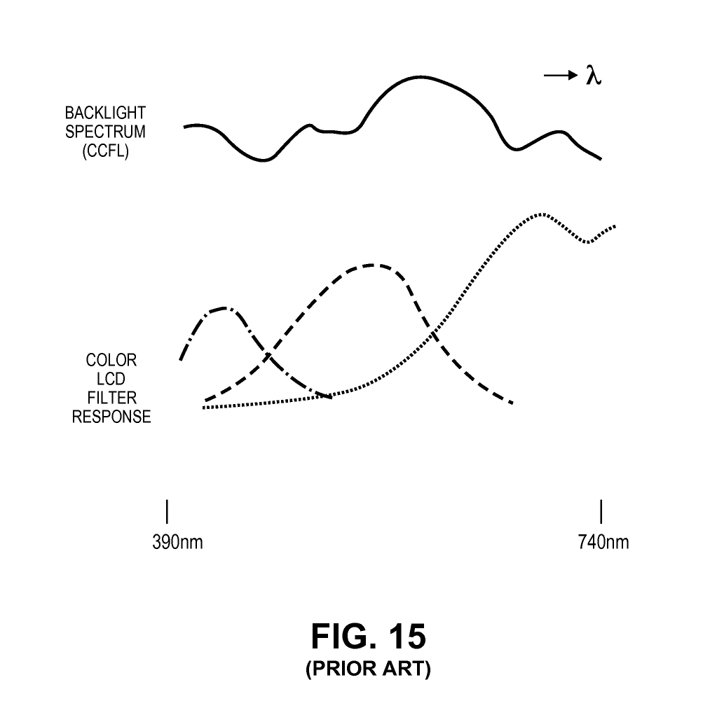

In continued reference above about dual modulator display systems comprising two monochrome LCDs and a white-light (or broad spectrum) source of light. FIG. 15 shows the spectrum of a conventional CCFL white light. It will be seen that there are some peaks and trough associated with such CCFL spectrum. In addition, FIG. 15 shows the typical color filter response from a conventional LCD with colored subpixels. It may be seen that there is some cross-talk (or bleed-through) of illumination in some parts of one color band (e.g., blue) into and through another color band, (e.g. a green colored subpixel). The result of which—i.e., once the CCFL light is filtered by conventional colored subpixels in a LCD—is that the resulting illumination may still be an uneven one overall, still showing some peaks and troughs of color spectrum illumination. The color gamut represented by such a system would be limited to the choice of the color filters in the LCD.

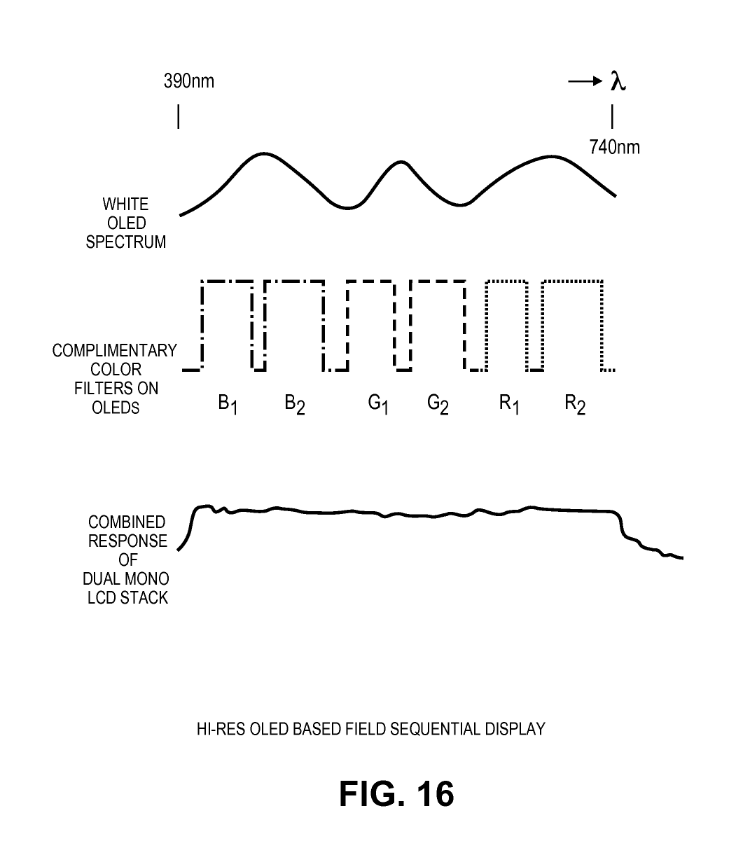

FIG. 16 shows one possible embodiment of using specific colored filters on backlights using either narrowband or broadband emitters for lighting. In the case of narrowband, the emitters may be LED, OLED, laser, quantum dots or the like. In the case of broadband, the emitters may be LED, OLED, CCFL or the like. When the spectra of these emitters are combined, the result is a substantially white source or broad spectrum source of light. For example, FIG. 16 shows a white spectrum as produced by OLED emitters that exhibits its particular peaks and troughs over the visible spectrum as shown. If suitable color filters were employed over this OLED white source in a complementary fashion—i.e., tune the band pass for the light sources with choice of for example, B1, B2, G1, G2, R1 and R2 filters, such that the peaks and troughs in the visible spectrum may be compensated for with a desired band pass, then the combined response of the white source OLED emitters, together with suitably chosen color filters, would exhibit a reasonably smooth illumination across the entire visible spectrum.

As may be noted in reference to FIG. 2 above, if two or more sets of primary colored filters are constructed such that each set may produce a broad (e.g. white) spectrum, then these two or more sets of primary colored filters may provide the novel field-sequential illuminations. The resulting overall gamut of each of these sets of primary colored filters may provide a wider gamut performance than if the display system were to use just one of these sets of primary colored filters.

It will be appreciated that, although many embodiments described herein are applicable to edge-lit backlighting systems, many of these systems and techniques are also applicable to direct-view backlighting that may have the potential for affecting a field-sequential illumination.

In one embodiment, the two sets of primary colored filters may be specifically selected in their band passes to be complementary to enable spectral separation 3D viewing. In such a case, then viewers wearing spectral separation glasses would be able to view images in 3D in such a display system. Spectral separation 3D viewing and systems are known in the art—e.g., in United States Patent Application Publication Number 20110205494 entitled “SPECTRAL SEPARATION FILTERS FOR 3D STEREOSCOPIC D-CINEMA PRESENTATION”, which is hereby incorporated by reference in its entirety.

A detailed description of one or more embodiments of the invention, read along with accompanying figures, that illustrate the principles of the invention has now been given. It is to be appreciated that the invention is described in connection with such embodiments, but the invention is not limited to any embodiment. The scope of the invention is limited only by the claims and the invention encompasses numerous alternatives, modifications and equivalents. Numerous specific details have been set forth in this description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

1. A display system comprising:
a backlight source, said backlight source providing light into an optical path;
a first modulator, receiving light from said backlight source and transmitting said light into said optical path;
a second modulator, receiving light transmitted from said first modulator and transmitting said light;
a controller, said controller inputting image data to be rendered upon said display system and sending signals to said backlight source, said first modulator and said second modulator; and
further wherein said controller sends signals to said backlight source to affect a field sequential illumination for said display system.

2. The display system as recited in claim 1 wherein said backlight source comprises an edge-light for said display system.

3. The display system as recited in claim 2 wherein both said first modulator and said second modulator comprise LCD displays.

4. The display system as recited in claim 3 wherein both said first modulator and said second modulator comprise monochrome LCD displays, said monochrome LCDs displays further comprising monochrome subpixels.

5. The display system as recited in claim 4 wherein said edge-light further comprises:
a first set of colored primary emitter; said first set of colored primary emitters defining a first color gamut;
a second set of colored primary emitters, said second set of colored primary emitters defining a second color gamut; and
further wherein said controller illuminates said first set of colored primary emitters and said second colored primary emitters in an alternating pattern to achieve a final color gamut.

6. The display system as recited in claim 5 wherein said alternating pattern substantially achieves at least a six primary color gamut.

7. The display system as recited in claim 5 wherein said alternating pattern comprises at least one field of white illumination.

8. The display system as recited in claim 5 wherein said alternating pattern comprise a higher frequency of high-luminance color fields than lower-luminance color fields.

9. The display system as recited in claim 4 wherein said display system further comprises:
a lenticular lens sheet, said lenticular lens sheet receiving light from said second modulator; and
further wherein said light emanating from said lenticular lens sheet affects an autostereoscopic 3D view.

10. The display system as recited in claim 9 wherein further the lenses of said lenticular lens sheet comprise substantially the same dimension as subpixels of second modulator.

11. The display system as recited in claim 4 wherein said display system further comprises:
a matched polarizer, said matched polarizer inputting light from said first modulator and transmitting said light to said second modulator.

12. The display system as recited in claim 11 wherein said display system further comprises:
stand-alone viewing glasses, said stand-alone viewing glasses being wearable by viewers of said display system; and
further wherein said matched polarizer and said stand-alone viewing glasses provide a 3D view of the image rendered by said display system.

13. The display system as recited in claim 4 wherein said subpixels of said second modulator are switched at a higher frame rate as subpixels of said first modulator and
wherein said display system further comprises stand-alone active shutter viewing glasses, said active shutter viewing glasses being synchronizable with said subpixels of said second modulator to affect a 3D view of the images rendered by said display system.

14. The display system as recited in claim 4 wherein said display system further comprises:
a multi-view spatial processor, said multi-view spatial processor capable of outputting multiple channels of image data to affect multiple 3D views of the images rendered by said display system.

15. The display system as recited in claim 14 wherein said display system further comprises:
a MVC decoder, said MVC decoder inputting an encoded video stream and outputting multiple bitstreams, each of said bitstreams representing one view of said video stream.

16. The display system as recited in claim 4 wherein further said controller comprises:
an image processing pipeline, said image processing pipeline receiving image data, providing scene analysis of said image data and providing signals for said backlighting source and said first and said second monochrome LCD modulators.

17. The display system as recited in claim 16 wherein said image processing pipeline further comprises:
an image histogram generator, said histogram generator providing histograms for a plurality of color channels within an image frame;
a dynamic leveler, said dynamic leveler providing signals for illuminating said backlighting source depending upon said histograms for said image frame; and
a dynamic rescaler, said dynamic rescaler providing signals for controlling said first and second LCD modulators.

18. The display system as recited in claim 17 wherein said image processing pipeline further comprises:
a gamut mapping algorithm for analyzing the image data and determining the virtual primaries for field sequential illumination.

19. The display system as recited in claim 18 wherein said image processing pipeline further comprises:
a subpixel rendering algorithm for producing signals for the subpixels of said first and said second LCD modulators.

20. A broad-spectrum backlight system comprising:
a set of emitters, each of said emitter emitting light in a spectrum band such that the combined light provides a broad spectrum emission;
a set of colored filters providing filter for light of said emitters, each colored filter comprising a primary color band pass such that the combined light from said set of colored filters provide a substantially uniform luminance across a broad spectrum.

21. The backlighting system as recited in claim 20 wherein said backlighting system comprises at least two sets of colored filters, such that for each set of colored filters is capable of providing a broad spectrum illumination for said backlighting.

22. The backlighting system as recited in claim 21 wherein said at least two sets of colored filters provide two color gamuts in a field sequential illumination pattern.

23. The backlighting system as recited in claim 21 wherein said at least two sets of colored filters are selected such that each set is complementary to a band pass to affect spectral separation for 3D viewing.
